(19) United States
(12) Patent Application Publication
(10) Pub. No.: US 2003/0135548 A1
(43) Pub. Date: Jul. 17, 2003

(54) System and method for disseminating knowledge over a global computer network

(76) Inventor: Arthur A. Bushkin, Fairfax, VA (US)

Correspondence Address: SHAW PITTMAN LLP, 1650 TYSONS BOULEVARD, MCLEAN, VA, 22102, US

(21) Appl. No.: 10/319,691

(22) Filed: Dec. 16, 2002

Related U.S. Application Data
(60) Provisional application No. 60/339,747, filed on Dec. 17, 2001.

(51) Int. Cl. G06F 15/16; G06F 15/173

(52) U.S. Cl. 709/203; 709/245

(57) ABSTRACT

The present invention is a system and method for serving information resources accessible through a computer network. According to an embodiment, the method includes receiving a URL address containing an invalid file name, intercepting a 404 error caused by the invalid file name, consulting a database that associates unique identifications with information resources, identifying the invalid file name as one of the unique identifications in the database, and serving an information resource associated with the one unique identification.

This application claims the benefit of U.S. Provisional Application No. 60/339,747, filed Dec. 17, 2001, which is herein incorporated by reference in its entirety.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field of the Invention

The present invention relates generally to a system and method for addressing information resources on a global computer network, and for navigating to those information resources through the global computer network.

2. Background of the Invention

The Domain Name System (DNS) is the cornerstone of Internet communication. The DNS and its associated domain name servers translate alphanumeric Internet addresses, such as www.stargazernet.net, into the Internet Protocol (IP) addresses that computers use, such as 123.34.45.567. Thus, when an Internet user wants to contact a destination on the Internet (e.g., a web site), the user enters the alphanumeric address into a web browser and the DNS translates the alphanumeric address to a numeric IP address. With the IP address established, the user's computer and the destination computer can exchange information, such as e-mail or web pages.

The DNS organizes alphanumeric domain names into a hierarchy of major domains and minor domains. For example, in the address stargazernet.holodeck.net, the major, or top, domain is .net, while the minor domain is .holodeck. The stargazernet in the address identifies the computer that is hosting the StargazerNET program.

Within a particular address, files of information resources (e.g., web pages) are stored in directories and subdirectories. For example, in the address, stargazernet.holodeck.net/animalpics/mammals/dolphin.htm, the file dolphin.htm, containing an image of a dolphin, is stored in the directory /animalpics, within the subdirectory /mammals. A user can access a particular file by entering the domain name, directories, and file name. Alternatively, the user can enter the domain name only, and then use web navigation buttons provided on the web site to locate and access the desired file.

Before a user can access a particular file using the domain name and directory address, the administrator of the host web site must create the directories, subdirectories, and file names. If the user attempts to access a directory or file that does not exist, the web server of the host web site returns a web browser error message, such as a “404—File Not Found” error message. FIG. 1 illustrates a typical 404-error message. This error indicates that a user has entered a valid domain name into the browser, and has arrived at the web site corresponding to that domain name, but that the specific file (e.g., a web page such as the dolphin.htm file described above) that the user is looking for cannot be found. That specific file might have been, for example, deleted from the web site or moved to a different location (e.g., directory or subdirectory).

In many instances, rather than returning a generic web browser error message such as the one shown in FIG. 1, web site administrators prefer to have their web server display a customized 404-error page that redirects a visitor back to their site's home page. This customized message creates a more professional appearance for visitors, keeps the visitors on the web site, and provides a more user-friendly site experience. FIG. 2 illustrates an example of a customized 404-error page, which results when a user enters an invalid directory or file name for the domain name cnn.com. As shown, the web site redirects the user to the home page of cnn.com and offers customized guidance on locating the particular page, including the option of entering terms in the web site's search engine.

Another method of error handling enables a user to enter in a browser a word (or words) that is not a domain name. The web browser companies sell these “keywords” to web sites that wish to expand access to their site. For example, a user may type “google,” in response to which the browser may take the user to www.google.com, sponsored by the web search engine, GOOGLE™. To perform this navigation, a browser company maintains a database that associates keywords with domain names. The browser company also typically requires an agreement with and payments from the web site that is using the keyword.

With each of these error-handling methods, a critical limitation concerns the creation of the directory or file. The web site administrator must pre-create the directories and files before any navigation is possible. In general, a user cannot create information resources (e.g., web pages) on a host site and has no control over the ability to navigate to a particular information resource.

In some instances, however, a user can create an information resource such as a search results page. For example, in response to a user's entering search terms, a web search engine such as GOOGLE™ executes the search, creates a web page, and posts the results of the search on the web page. Unfortunately, this created information resource lacks an address that is conducive to user-friendly web navigation. The address for the web page is typically long, with many characters that are unrecognizable to ordinary users. In addition, the address generated by the search engine is temporary, and is eventually deleted to avoid congesting a search engine web site with a large number of addresses. Thus, although the information resource and its web address may be automatically generated, the user still has no convenient way to share the address or resource with other users, even assuming the resource remains available (i.e., is not deleted) to do so.

### SUMMARY OF THE INVENTION

The present invention is a system and method for serving information resources accessible through a computer network. According to an embodiment, the method includes receiving a URL address containing an invalid file name, intercepting a 404 error caused by the invalid file name, consulting a database that associates unique identifications with information resources, identifying the invalid file name as one of the unique identifications in the database, and serving an information resource associated with the one unique identification.

Another aspect of the present invention is a system and method for providing direct access to information resources through a computer network. According to this aspect, each information resource is assigned a unique identification. Then, to access an information resource, a user enters into, for example, a conventional web browser a uniform resource locator (URL) address that includes the domain address of a host web site followed by the unique identification of the information resource. In response, the web browser contacts the web server of the host web site using the domain address and passes along the unique identification. The host web server retrieves the information resource corresponding to the unique identification and presents the information resource to the user.

In an alternative embodiment, a user enters only the unique identification into a dedicated browser input, which then inserts the domain address of the host web site to which the identification should be sent. This dedicated browser input, referred to herein as a transporter, can be provisioned on the host web site or another web site.

The present invention therefore enables a user to directly access information resources available through a computer network, from any web browser, without requiring the user to be on the web site on which the information resources are stored. For example, if the host web site is www.stargazernet.net, a user can simply enter www.stargazernet.net/ followed by the unique identification of an information resource. In response, the present invention identifies the web site of the information resource and transports the user directly to the information resource on the particular web site. This redirection is performed transparently, without requiring the user to know the host name of the web site that has the information resource, and without requiring the directory structure to be displayed.

In a further aspect of the present invention, a user can communicate the direct access URL address (i.e., the host web site domain address and unique identification) to other users, to facilitate their convenient and immediate access to the information resource. For example, a user can e-mail the URL address to friends. In addition, a user can embed the URL address into email messages or text documents that support hotlinks. In this manner, the friend can simply click on the hotlink to launch a browser that processes the URL address and transports the friend directly to the information resource.

In essence, the present invention provides a new web-addressing scheme, which supplements the generic client-reading processes of traditional web addressing with an additional addressing layer. By automatically creating unique identifications for information resources and invoking a novel DNS error redirection, the present invention provides users with convenient, direct access to Internet resources. Indeed, the present invention gives users the ability to create information resources on demand, and then to immediately share those resources with other users using the dynamically generated unique identifications and URL addresses.

### BRIEF DESCRIPTION OF THE DRAWINGS

FIG. 1 is a screen image of a typical 404-error message.

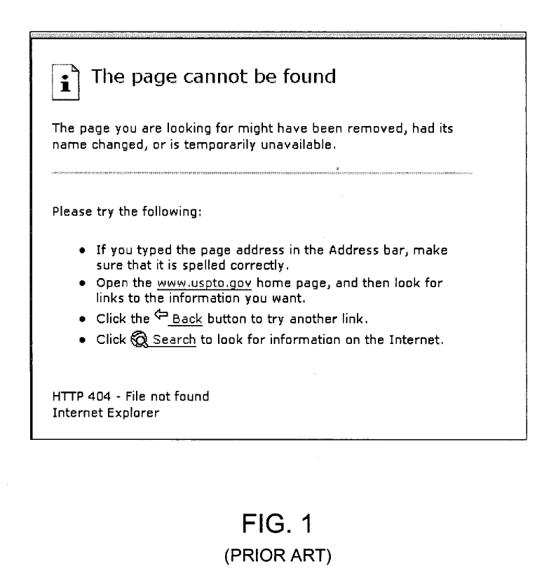

FIG. 2 is a screen image of a customized 404-error message.

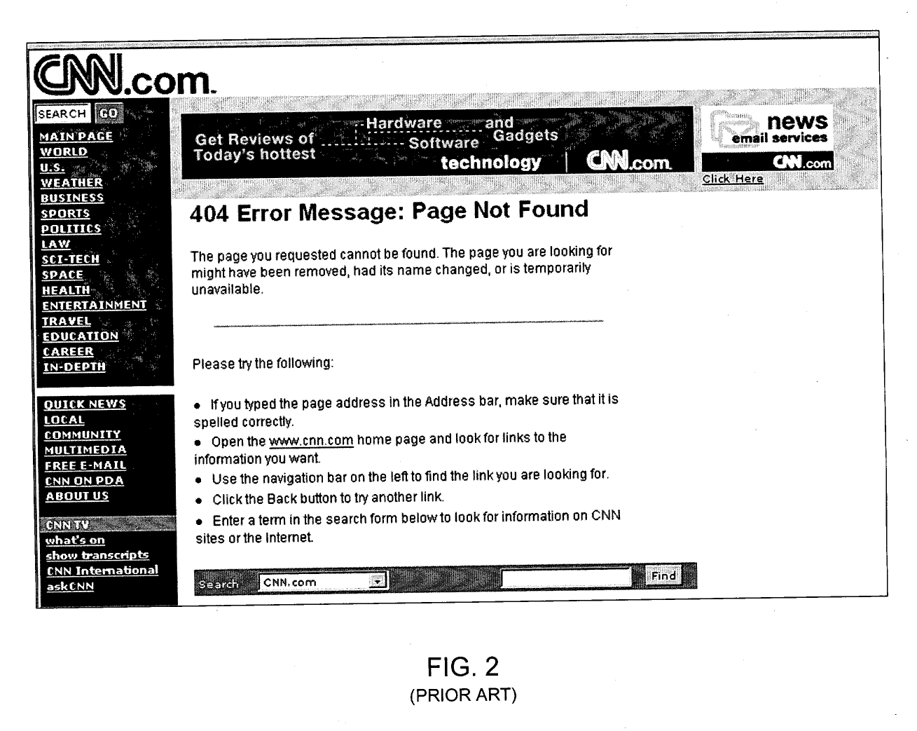

FIG. 3A is a schematic diagram of an exemplary system for addressing information resources on a network, and for providing direct access to those information resources through the network, according to an embodiment of the present invention.

FIG. 3B is a flowchart outlining an exemplary method for addressing information resources on a network, and for providing direct access to those information resources through the network, according to an embodiment of the present invention.

FIG. 4 is a screen image of a browser address bar for entering a unique identification, according to an embodiment of the present invention.

FIG. 5 is a screen image of a transporter for entering a unique identification, according to an embodiment of the present invention.

FIG. 6 is a flowchart outlining a DNS error redirection process, according to an embodiment of the present invention.

FIG. 7 is a screen image of a customized navigation error page according to an embodiment of the present invention.

### DETAILED DESCRIPTION OF THE INVENTION

An embodiment of the present invention provides a system and method for addressing information resources on a computer network, and for providing direct access to those information resources through the computer network. The system and method assign unique identifications to information resources, and use those unique identifications to enable users to navigate to the information resources through a novel, web-address redirection process. Unlike the addressing conventions of the prior art, which necessitate that a web site administrator pre-create and constantly update directories and file names, the present invention can automatically create unique identifications for information resources and provide direct access to the information resources using automatically updated addresses.

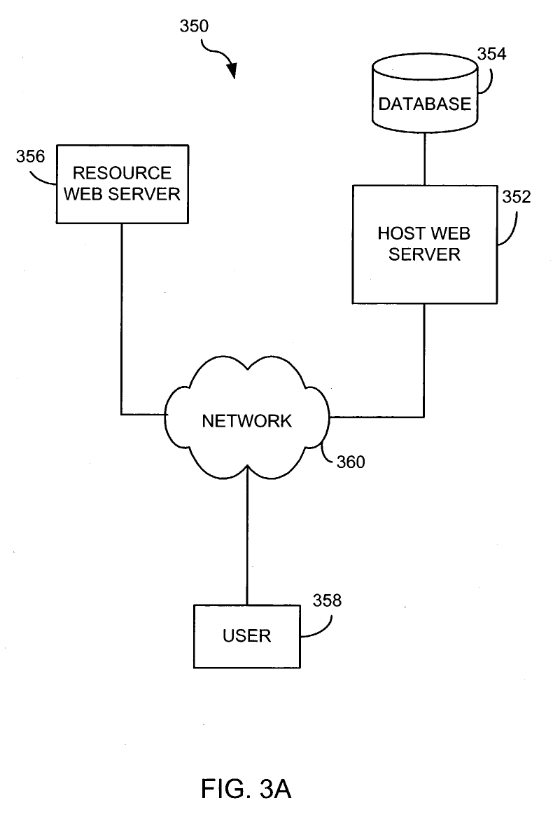

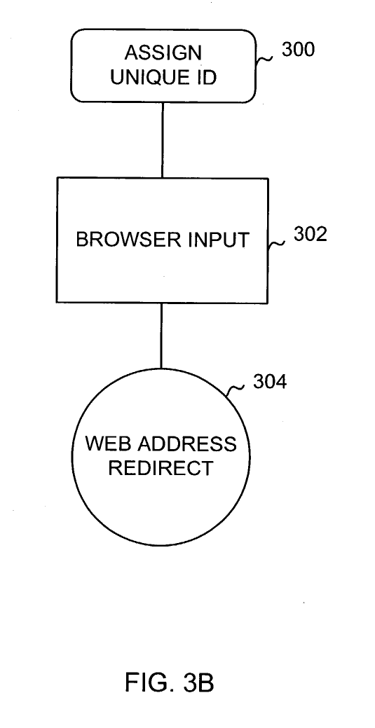

FIG. 3A illustrates an exemplary system 350 according to an embodiment of the present invention. As shown, system 350 includes a host web server 352, a database 354, a resource web server 356, a user 358, and a network 360. Host web server 352 is in communication with database 354. Although shown separately, database 354 could, of course, be provisioned on host web server 352. Host web server 352 is also in communication with resource web server 356 and user 358 through network 360. Network 360 is, for example, a global computer network such as an intranet or the Internet.

Host web server 352 operates the exemplary method of the present invention as described below. In an embodiment of the present invention, host web server 352 executes the exemplary method through a host web site. The entity that operates and maintains host web server 352 and the host web site is referred to herein as the “system administrator.”

Database 354 stores associations between unique identifications and information resources. Host web server 352 defines these associations between the unique identifications and the information resources, either automatically or at the direction of a user. With the associations defined, in response to a given unique identification, host web server 352 consults database 354 and identifies the information resource associated with the given unique identification. Host web server 352 then provides access to the information resource.

An information resource includes any destination, activity, or source of information accessible through network 360. Information resources can be stored on host web server 352, on resource web server 356, and, although not shown, on any other computer or server in communication with network 360.

User 358 is in communication with network 360 through, for example, an Internet service provider. User 358 communicates with host web server 352 using a network browser application, such as a web browser.

With continuing reference to the exemplary system 350, FIG. 3B illustrates, on a broad level, an exemplary method according to an embodiment of the present invention. As shown, in step 300, the method begins by assigning (preferably, automatically) a unique identification to an information resource. In the simplest example, the information resource is a web page. In an exemplary implementation of the present invention, examples of information resources include collaborations, moderated discussions, message boards, distance learning sessions, StarBases, StarQuests, StarGuides, and StarTours. These information resources and the context in which they operate are described in the related co-pending application U.S. application Ser. No. 10/151,878, filed May 22, 2002, which is hereby incorporated by reference in its entirety.

When an information resource is identified, for example, by a user 358 interacting with the host web site of host web server 352, host web server 352 automatically assigns it a unique identification. These automatically created unique identifications could be, for example, sequential numeric identifications, or “StarIDs” (e.g., SQ-3333-4444-5555) as described in the related application. In assigning a unique identification, host web server 352 automatically generates the identification, stores the identification in database 354, and associates the identification with the information resource in database 354.

Alternatively, instead of host web server 352 automatically creating unique identifications, the system administrator can manually create unique identifications and store them in database 354. These manually created identifications could be, for example, alphanumeric identifications, or “StarWords” (e.g., Points of Light Foundation) as described in the related co-pending application U.S. application Ser. No. 10/151,878, filed May 22, 2002, which is hereby incorporated by reference in its entirety. In manually creating the StarWords, the system administrator ensures that no two information resources receive the same alphanumeric identification. For example, the system administrator could maintain a list of active alphanumeric identifications, and would associate each with a destination corresponding to the particular information resource. Notably, these alphanumeric identifications can include blank spaces (discussed below). In addition, multiple unique identifications can be associated with the same information resource. For example, the unique identifications “Points of Light” and “Points of Light Foundation” could both be associated with the home web page of the Points of Light Foundation.

Host web server 352 stores the unique identifications and their associated information resources in database 354. This database 354 enables host web server 352 to identify and navigate to an information resource when it receives the corresponding unique identification.

In generating the unique identification, the present invention provides a permanent pointer to an information resource. This pointer operates independently from file-naming conventions on the Internet. In other words, unlike traditional web addresses that typically contain a file name ending in, for example, .htm, .html, or .asp, the present invention points to the location of an information resource using a unique identification that does not identify a specific file name. In essence, the unique identification acts as an additional address, offering an added layer of navigation. And, when compared to the long and unrecognizable addresses generated by search engines to point to search result pages, the unique identification (e.g., a StarID or StarWord as described in the related application) is more simple and usable for the user, providing a more convenient and intuitive navigation scheme. In addition, the present invention can serve as a security tool, preventing unauthorized users from learning where content is located.

Again referring to FIG. 3B, after a unique identification has been assigned to the information resource, in step 302, a user 358 enters the unique identification into a web browser input. This browser input can be, for example, an address bar of a web browser, a data entry field on a web site affiliated with the host web site (referred to herein as an “affiliated transporter”), or a data entry field on the host web site of host web server 352 (referred to herein as a “transporter”).

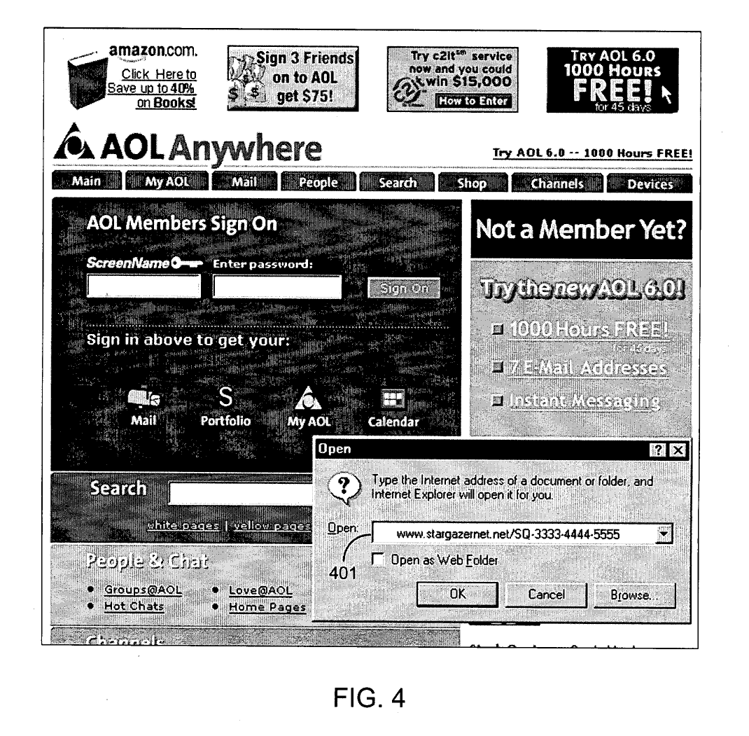

If the browser input is an address bar of a web browser, then a user enters a uniform resource locator (URL) address that includes the full domain name of the host web site of host web server 352, followed by the unique identification (e.g., www.stargazernet.net/SQ-3333-4444-5555). FIG. 4 illustrates this situation, in which a user has activated an address bar 401 of the browser (by typing “control-O”) and entered the URL address. In response to this input, the browser contacts host web server 352 through network 360 and passes along the URL address, with the unique identification as a parameter.

If the browser input is an affiliated transporter, then a user need only enter the unique identification. According to an embodiment of the present invention, the affiliated transporter is configured to append the unique identification to the full domain name of the host web site to create a URL address. Then, functioning like a web browser, the affiliated transporter contacts the host web server 352 of the host web site and passes along the URL address, with the unique identification as a parameter.

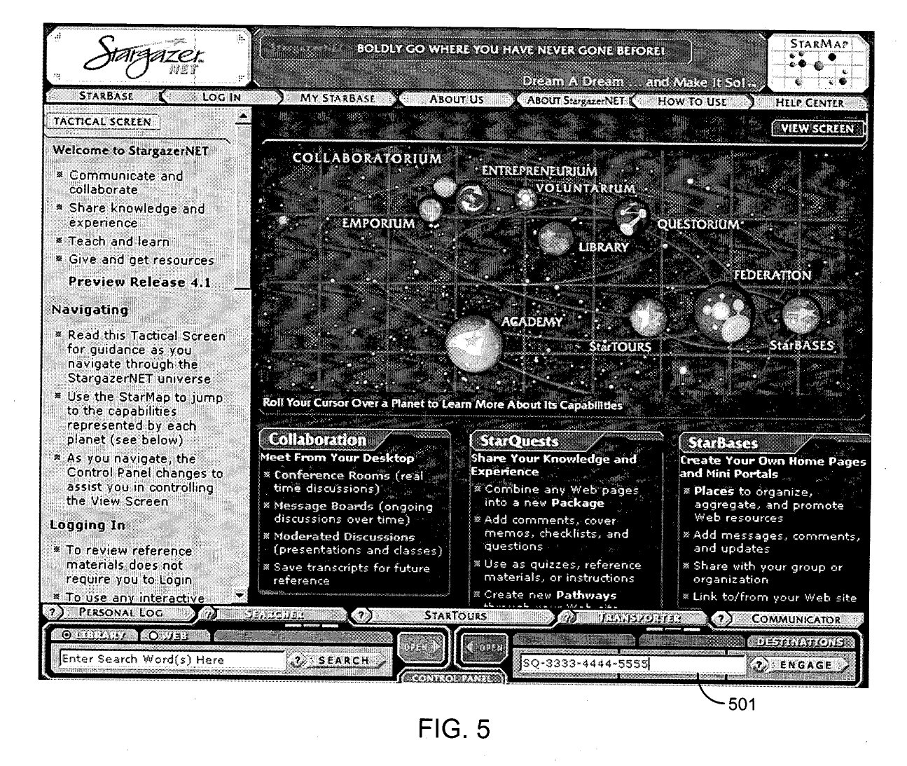

If the browser input is a transporter on the host web site of host web server 352, then a user, again, need only enter the unique identification of the information resource (e.g., SQ-3333-4444-5555). FIG. 5 illustrates an exemplary host web site (www.stargazernet.net) having a transporter 501 into which the user has entered the unique identification. In response to this input, the transporter on the host web site is configured to append the unique identification to the domain name of the host web site to create a URL address, in which the unique identification is a parameter.

Thus, whether entered into an address bar, affiliated transporter, or transporter, at the conclusion of step 302, host web server 352 has a URL address that includes the unique identification as a parameter.

In a further aspect of the present invention, the browser input is a web browser working in conjunction with a software application that supports hotlinks. For example, applications such as MICROSOFT OUTLOOK™ and MICROSOFT WORD™ enable users to insert URL address hotlinks into e-mail and text documents, respectively. A user can then click on these hotlinks within the e-mail or text document to automatically launch a web browser that takes the user to the web page corresponding to the URL address. Thus, in this embodiment, a user creates a hotlink pointing to a URL address containing the domain name of the host web site and the unique identification of the information resource.

Referring again to FIG. 3B, after host web server 352 receives the unique identification, in step 304, the host web server 352 invokes a novel web navigation redirection process. Specifically, host web server 352 parses the URL, examines the characters appearing after the first backslash “/” in the URL, and determines if those characters match an existing unique identification. If the unique identification does exist, then host web server 352 directs the user to the information resource corresponding to the unique identification. If the unique identification does not exist, then host web server 352 presents an error page.

Thus, when a user 358 types a unique identification into a browser input, the browser input passes the unique identification to the host web site as a parameter. Because the unique identification does not correspond to a conventional file name of a file stored on host web server 352, host web server 352 would normally return a standard DNS 404-error. In the present invention, however, host web server 352 intercepts the 404-error and redirects the requester either to the information resource corresponding to the unique identification, or, if none exists, to an error page containing a list of existing unique identifications and the information resources to which they correspond.

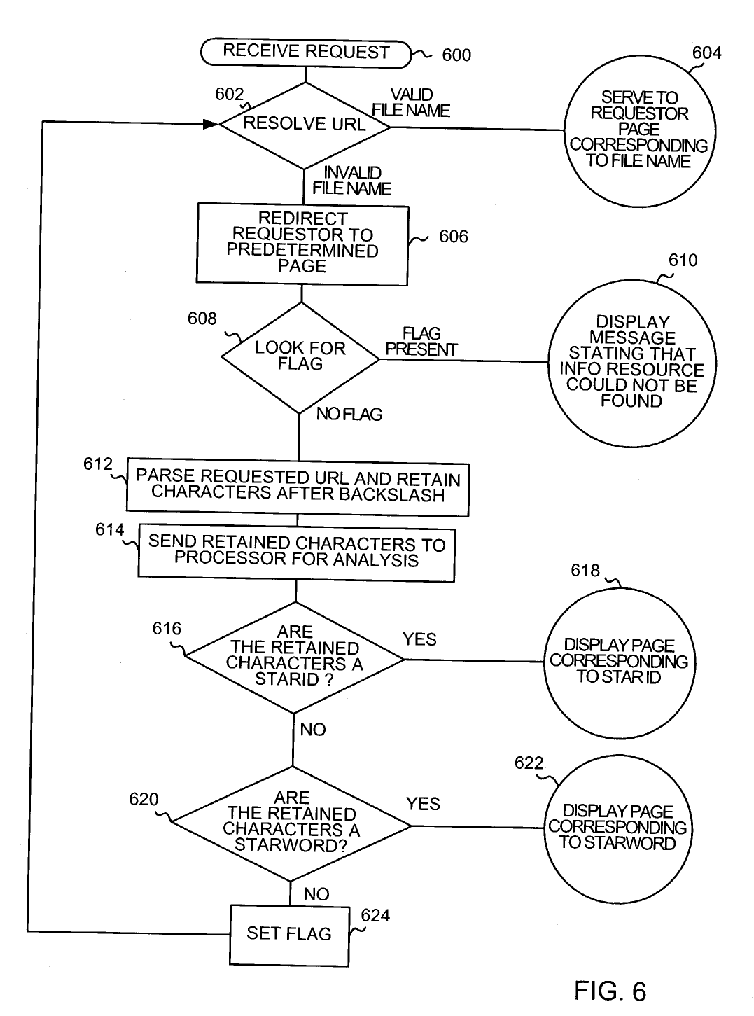

The flowchart of FIG. 6 outlines this redirection process in more detail. As shown, in step 600, host web server 352 receives an information request that includes a URL address. This URL address includes the domain name of the host web site of host web server 352, followed by a parameter after the backslash “/”. The parameter is either a valid file name, as with ordinary web navigation, or a unique identification, according to the present invention.

In step 602, host web server 352 resolves the URL address to determine if the parameter in the URL address is a valid file name, which corresponds to a page on host web server 352. If the parameter is a valid file name, then host web server 352 serves to the requestor (e.g., user 358) the page corresponding to the file name, as shown in step 604.

If, in step 602, host web server 352 determines that the parameter is not a valid file name, then in step 606 host web server 352 redirects the requestor to a predetermined page of the host web site.

In step 608, the predetermined page looks for a flag that indicates that host web server 352 has already analyzed the invalid file name parameter. (This setting of this flag is described below, as a later part of this process.) If the flag is present, then in step 610 host web server 352 displays a message stating that host web server 352 could not find an information resource corresponding to the parameter. In other words, the invalid file name parameter is also an invalid unique identification. The displayed message could also include a customized error message that lists valid unique identifications and the information resources to which they correspond, so that the user can browse for different options.

If, in step 608, the flag is not present, then in step 612 the predetermined page of host web server 352 parses the URL address and retains all of the characters appearing after the first backslash “/” (e.g., after www.stargazernet.net/).

In step 614, the retained characters are sent to a processor of host web server 352. The processor analyzes the retained characters to determine if they match any unique identifications. The retained characters could be a StarWord, such as “hunger” or “Red Cross,” or could be a StarID consisting of a two-character alphanumeric identification followed by a series of numbers, such as in the form of AA-XXXX-XXXX-XXXX or AAXXXXXXX.

The processor is configured to recognize whether the retained characters are in a form appropriate for a unique identification. For example, in step 616, the processor determines whether the first two characters of the retained characters match any one of the two-character prefix codes established for StarIDs. If the first two characters do match a StarID prefix and all of the retained characters match a valid StarID, then in step 618 host web server 352 displays the information resource (e.g., web page) corresponding to the StarID. Optionally, instead of checking the StarID prefix first, the processor could simply look to see if all of the retained characters match a valid StarID.

If, in step 616, the retained characters do not match any StarID, then in step 620 the processor determines whether the retained characters are a reserved StarWord. If the retained characters are a StarWord, then in step 622 host web server 352 displays the information resource (e.g., web page) corresponding to the StarWord.

If, in step 620, the processor determines that the retained characters do not match any StarWord, then, in step 624, the processor sets the flag (discussed above in reference to step 608) indicating that the invalid file name parameter has been analyzed to determine whether it is a valid unique identification (e.g., a StarID or a StarWord). The process then returns to step 602.

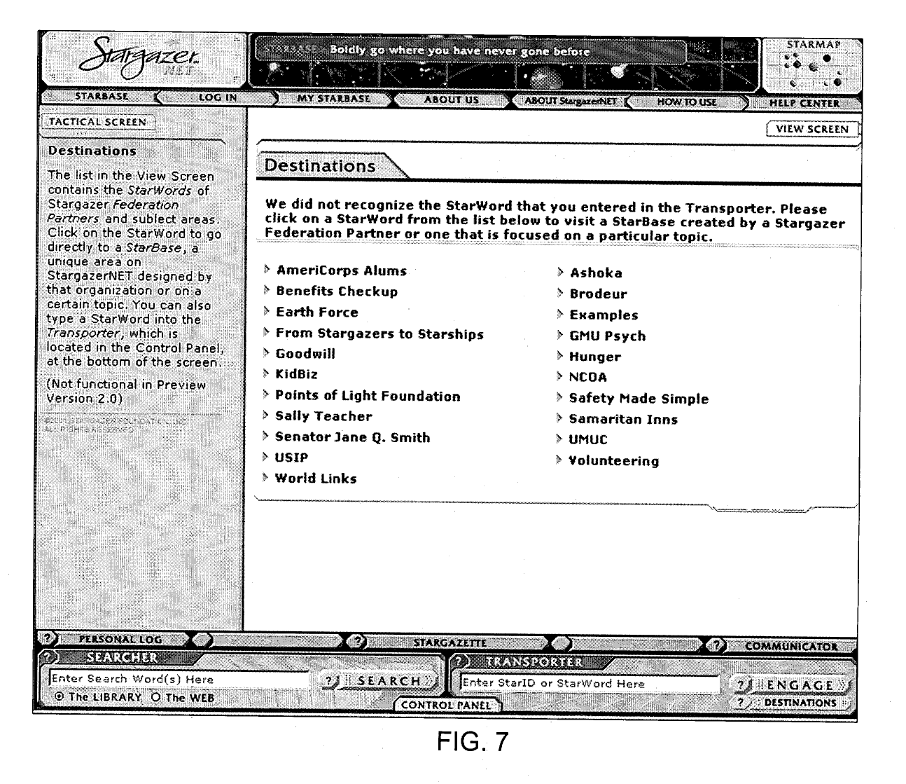

With the flag now set, the process proceeds from step 602 through step 608 as described above. At step 608, because the flag is present, the process proceeds to step 610. In step 610, host web server 352 displays a customized error page to the requestor stating that the information resource could not be found. This error page could, for example, list a group of valid unique identifications (e.g., StarIDs and StarWords) from which to choose. FIG. 7 shows an exemplary customized error page that enables a user to click on valid StarWords.

In intercepting the DNS 404-error and analyzing the URL address, the present invention provides many benefits in comparison to conventional web navigation. As one example, by parsing and analyzing the URL address, the present invention can accept spaces in the address. In contrast, conventional URLs do not permit spaces in the URL address, which is the reason that addresses often contain underscores, dashes, and other filler characters. Thus, with the present invention, a user can use an address such as www.stargazernet.net/Points of Light Foundation.

Using the unique addressing scheme described above, the present invention provides browser-enabled dynamically generated URLs. These URLs serve at least three functions: 1) redirection; 2) launching; and 3) pulling content. In redirection, the URL is placed in e-mail, text, buttons, or StarQuests, for example. When activated, the user is taken to the host web site (e.g., StargazerNET) or to an alternate site. For launching, the URL launches a page or a program. Finally, for pulling content, clicking on the URL pulls content from the host web site or the alternate site. In sum, the present invention provides a generic redirect, launch, and pull strategy, which is described below under corresponding subheadings.

Redirection

By entering URLs with unique identifications into browser inputs, the present invention can redirect web navigation to a host web site or an alternate site. As discussed above, this browser input could be, for example, a transporter, an affiliated transporter, a web browser address bar, or a hotlink.

As a part of this redirection, the present invention also gives the host web site or alternate site the ability to recognize a requestor. By way of background, traditional hyperlink buttons have code pointing to the host web site. Clicking on the button sends the user to the host web site. Unless the server of the host web site has sophisticated software that detects the web site from which the message is coming, all that the host web site recognizes is that a request is coming through a particular Internet service provider (e.g., AOL). The host web site server sends back the corresponding file through the Internet service provider, the Internet service provider passes the file to the requestor's computer, and the requestor sees the page. Thus, with conventional web navigation, the host web site cannot determine that the requestor navigated from a particular web site, only that the request came through the particular Internet service provider.

In contrast to these traditional hyperlinks, in the present invention, the host web site can use the unique identification to identify the originating web site. For example, a portion of the unique identification can identify the web site from which the request originates. Thus, in the case of an affiliated transporter, the software code that operates the affiliated transporter could insert a series of characters after the unique identification entered by the user. For example, if the user enters the StarID “SQ-0000-0000-0100”, the transporter could insert the domain name of the host web site (www.stargazernet.net) followed by a first backslash and the StarID, which would then be followed by a second backslash and an identifier for the affiliated web site (e.g., the identifier “444,” which corresponds to a fictitious ABC Company). Thus, the affiliated transporter would send the following URL address to the host web site: www.stargazernet.net/SQ-0000-0000-0100/444). The host web site server would recognize the “444” identifier as corresponding to the ABC Company.

In this manner, the host web site server can recognize the web site from which a request originates, and can customize its response accordingly. For example, a user submitting a request through an affiliated transporter on the fictitious ABC Company web site can be greeted with a tailored message such as the following: “Welcome, ABC Company employee. Thank you for participating from your work desktop.”

In another embodiment, the present invention can customize the response of the host web site server even further by using additional components of the unique identification. For example, in addition to an identifier for the affiliated web site (as represented by “/444”, for example), the unique identification could include a topical identifier that indicates the reason for the request. An exemplary affiliated transporter on the affiliated web site could, for example, be dedicated to linking the user to descriptions of featured nonprofit organizations (e.g., “Nonprofit Organization of the Week”). Another affiliated transporter on the same affiliated web site could be dedicated to linking the user to lists of monthly movie releases. The affiliated transporter for the featured nonprofit link could insert “/555” into unique identification, while the affiliated transporter for the movie link could insert “/666”. The URL addresses sent to the host web site would appear as follows: www.stargazernet.net/444/555 for the nonprofit link, and www.stargazernet.net/444/666 for the movie link. In this way, the host web site server can identify the originating web site and the reason the request is being forwarded, and can, accordingly, customize its response for a more efficient interaction with the user.

As another example of using a topical identifier to customize operation, a corporate web site might wish to feature a different corporate office every month. An affiliated transporter on the corporate web site could simply point to a unique identifier such as “Office of the Month,” which would be a StarWord appearing in the URL address as follows: www.stargazernet.net/Office of the Month. As the host web site, StargazerNET would read the StarWord and redirect the user to the web page describing the office featured for the particular month. For example, in April, the host web site server might redirect the user to a web page describing an Amsterdam office. In May, the host web site server might redirect the user to a Chicago office. Thus, essentially, the present invention could provide an advertisement delivery system and method, based on affiliated transporters.

Another benefit of the present invention is the ability for an affiliated web site to maintain an active link to an information resource, or to at least the host web site that maintains the information resource. For example, even if a user enters an invalid unique identification (e.g., a StarID that does not exist) into an affiliated transporter, the transporter will still direct the user to the host web site, which can, for example, as shown in FIG. 7, display a customized error page explaining that the unique identification does not exist and listing other, valid unique identification in which the user may be interested. Thus, even if an information resource is relocated or renamed on the host web site server, the user will still be directed to the host web site, without receiving the standard DNS errors encountered with conventional hyperlinking.

Another benefit of the present invention is the ease with which an affiliated web site can be provided a link to an information resource. In essence, the server of the affiliated web site has only to download the software that runs the affiliated transporter. Importantly, the affiliated web site server does not have to have any special software, web servers, or programming.

Another benefit of the present invention is the ability to provide direct access to an information resource through any web browser (or hotlink from an application and through a web browser). By associating individual identifications to information resources, the present invention essentially provides a completely new addressing layer on the web. Thus, any user with Internet access can conveniently create and immediately share information resources with other users. For example, at 2:00 PM, a user can create an information resource, such as a StarQuest. Then, at 2:01 PM, that user can call a friend and tell the friend the unique identification (e.g., StarID) of the information resource. At 2:02 PM, the friend can type the unique identification into a browser and directly navigate to the information resource.

Launching a Page or Program

Another aspect of the present invention is the ability to use the unique identification (e.g., StarID or StarWord) to launch a web page or an application. Information resources, such as StarQuests, could be Java Beans™ applications. Accordingly, a user could use the direct access link described above to launch an application, such as “Go look at Travelocity™.” A user could use that link to launch the application and then return to the location from which the user launched the application. In parsing the incoming URL address to read the characters after the first backslash, the system and method of the present invention can easily launch an application, in addition to redirecting the user to a web page.

Pulling Content

In pulling content, the present invention could pull content from the host web site to another web site, or from an alternate web site to another web site. A user could click on a transporter button to download a song, for example. Unlike traditional streaming, such as with Real Networks™, where Real Networks™ must program the button, the buttons of the present invention could be generic so that they can be reprogrammed by the owner of the other site and placed on the other site.

For pulling content, a user can click on a button on another site and pull streaming content down from StargazerNET. Alternatively, the content can be pulled from an alternate site (other than StargazerNET), such as Real Audio™ or Real Video™. Thus, a site could have buttons that a user clicks, and instead of going to the site with the content, the content is sent to the user on the site with the button (i.e., the affiliated web site). In this way, a content provider site can stream content.

Thus, the present invention could, for example, pull streaming content to show a movie through a broadband connection. For example, the link could be www.stargazernet.net/batman to show a Batman movie. As another example, the link could launch a commercial in a portion of the web site screen. If a user is on a law firm web site, for example, there could be three buttons in the upper right-hand corner reading: 1) “Click here and learn about tax law;” 2) “Click here and learn about real estate law;” and 3) “Click here and learn about securities law.” If a user clicks through one of the buttons, the browser goes, by way of the host web server, to the site that has the video (often a remote site), retrieves the video, and delivers the streaming video right on the law firm web site. This method allows for a central repository of streaming videos, as opposed to storing the large video data files on the law firm's web site or having to constantly redirect.

As another example, any school or publisher could send content. To accomplish this, the present invention provides a generic way of hooking the client to the source (having cooperative software provisioned on both sites). With public key cryptography, a user gets a code so that the administrator can then issue generic clients and send software. All that a user must do is prime the two privacy keys.

For redirecting navigation to third parties, however, the present invention would maintain a name database. The administrator of the redirection would give software code to another site, e.g., www.lawfirm.com, and if a user types in www.lawfirm.com/points of light foundation, the law firm web site would recognize the unique identification as corresponding to The Points of Light Foundation. The web server of the law firm would not know exactly where the redirect is supposed to go. The law firm's web server would just send it to the central repository, i.e., the web site of the host web server. The host web server recognizes the intended destination and performs the remote redirect. The host web server sends it to wherever Points of Light is supposed to go.

The foregoing disclosure of the preferred embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for serving an information resource to a user of a computer network comprising:
associating information resources with unique identifications;
receiving, at a host web server, a URL address containing a host name and a parameter, wherein the host name corresponds to the host web server;
if the parameter is a file name of a file stored on the host web server, serving the file to the user;
if the parameter is not a file name of a file stored on the host web server, determining whether the parameter is one of the unique identifications associated with the information resources; and
if the parameter is one of the unique identifications associated with the information resources, serving to the user an information resource associated with the one unique identification.

2. The method of claim 1, if the parameter is not one of the unique identifications associated with the information resources, displaying a list of the unique identifications to the user.

3. The method of claim 1, further comprising intercepting a 404 error that would normally be returned if the parameter is not a file name of a file stored on the host web site.

4. The method of claim 1, further comprising:
if the parameter is not one of the unique identifications associated with the information resources, associating the parameter with an indicator that indicates that the parameter is invalid;
receiving a second URL address having the host name and the parameter;
recognizing the indicator associated with the parameter; and
returning a message to the user stating that an information resource could not be found for the parameter, without checking whether the parameter is a file name of a file stored on the host web server and without checking whether the parameter is one of the unique identifications associated with the information resources.

5. The method of claim 1, wherein the parameter is one of the unique identifications and includes a space.

6. The method of claim 1, wherein receiving the URL address comprises the user entering the URL address into an address bar of a web browser on a computer in communication with the computer network.

7. The method of claim 1, wherein receiving the URL address comprises the user entering the parameter into a data entry field of an affiliated web server, and wherein the data entry field is adapted to append the parameter to the host name of the host web server to create the URL address and to transmit the URL address to the host web server.

8. The method of claim 7, wherein the data entry field is further adapted to add an origination identifier to the URL address, and wherein the origination identifier identifies the affiliated web server to the host web server.

9. The method of claim 7, wherein the data entry field is further adapted to add a topical identifier to the URL address, and wherein the topical identifier indicates a reason for receiving the URL address.

10. The method of claim 1, wherein receiving the URL address comprises the user entering the parameter into a data entry field of the host web server, and wherein the data entry field is adapted to append the parameter to the host name of the host web server to create the URL address.

11. The method of claim 1, wherein a portion of the parameter identifies a web site from which the URL address was sent.

12. The method of claim 1, wherein serving the information resource to the user comprises launching an application.

13. The method of claim 1, wherein serving the information resource to the user comprises streaming content from another web server through the host web server and to the user.

14. The method of claim 1, wherein receiving the URL address comprises the user activating a hotlink.

15. The method of claim 1, wherein the information resource is one of a web page, a collaboration, a moderated discussion, a message board, a distance learning session, a video, a song, and a software application.

16. A method for serving an information resource accessible through a computer network, the method comprising:
receiving, at a host web server, a URL address containing a host name of the host web server and a parameter that is not a file name of a file stored on the host web server;
intercepting a 404 error caused by the parameter's not being a file name of a file stored on the host web server;
consulting a database that associates unique identifications with information resources;
identifying the parameter as one of the unique identifications; and
serving the information resource associated with the one unique identification.

17. The method of claim 16, wherein the information resource is one of a web page, a collaboration, a moderated discussion, a message board, a distance learning session, a video, a song, and a software application.

18. The method of claim 16, wherein the parameter includes an identifier, and wherein the method further comprises:
consulting a database that associates identifiers with customized responses;
identifying the identifier as one of the identifiers;
identifying a customized response associated with the one identifier; and
customizing the information resource based on the customized response.

19. The method of claim 16, wherein the parameter includes a space.

20. The method of claim 16, wherein intercepting the 404 error comprises:
redirecting the URL address to a predetermined page;
parsing the URL address and retaining the parameter;
sending the parameter to a processor, wherein the processor consults the database and identifies the parameter as the one unique identification.

21. The method of claim 16, wherein receiving the URL address comprises a user entering the URL address into an address bar of a web browser on a computer in communication with the computer network.

22. The method of claim 16, wherein receiving the URL address comprises a user entering the parameter into a data entry field of an affiliated web server, and wherein the data entry field is adapted to append the parameter to the host name of the host web server to create the URL address and to transmit the URL address to the host web server.

23. The method of claim 16, wherein receiving the URL address comprises a user entering the parameter into a data entry field of the host web server, and wherein the data entry field is adapted to append the parameter to the host name of the host web server to create the URL address.

24. A method for navigating to information resources available over a computer network comprising:
receiving a selection of an information resource from a user;
automatically assigning a unique identification to the information resource;
associating the information resource and the unique identification in a database;
receiving, at a host web server, a URL address containing the unique identification, wherein the host web server does not have a file with a file name matching the unique identification;
determining from the database the information resource that is associated with the unique identification; and
providing access to the information resource.

25. The method of claim 24, further comprising intercepting a 404 error that would normally be returned because the host web server does not have a file with a file name matching the unique identification.

26. The method of claim 24, wherein receiving a selection of an information resource from a user comprises the user creating the information resource.

27. The method of claim 24, wherein the URL address comprises a host name followed by a backslash followed by a parameter, and wherein the unique identification is the parameter.

28. A method for serving information resources accessible through a computer network, the method comprising:
receiving a URL address containing an invalid file name;
intercepting a 404 error caused by the invalid file name;
consulting a database that associates unique identifications with information resources;
identifying the invalid file name as one of the unique identifications in the database; and
serving an information resource associated with the one unique identification.

29. The method of claim 28, wherein the URL address comprises a host name followed by a backslash followed by the invalid file name.

30. The method of claim 28, wherein the one unique identification includes a space.

31. A system for serving information resources accessible through a computer network, the system comprising:
means for receiving a URL address containing an invalid file name;
means for intercepting a 404 error caused by the invalid file name;
means for associating unique identifications with the information resources;
means for identifying the invalid file name as one of the unique identifications; and
means for serving an information resource associated with the one unique identification.

32. An addressing system for a computer network comprising:
a database that associates unique identifications with information resources; and
a host web server in communication with the computer network and the database, wherein the host web server is adapted to
receive from a user a URL address containing a unique identification that is not a file name of a file stored on the host web server,
intercept a 404 error caused by the unique identification not being a file name of a file stored on the host web server,
determine from the database an information resource associated with the unique identification, and
serve the information resource to the user.

33. The system of claim 32, wherein the host web server is further adapted to provide a data entry field in which a user enters the unique identification, and wherein the data entry field is adapted to append the unique identification to the host name of the host web server to create the URL address.

34. The system of claim 32, wherein more than one unique identification is associated with a single information resource.

35. The system of claim 32, wherein the host web server is further adapted to display to the user a list of the unique identifications and their associated information resources, if the unique identification does not match any unique identification in the database.
